(19) United States
(12) Patent Application Publication
(10) Pub. No.: US 2017/0272006 A1
(43) Pub. Date: Sep. 21, 2017

(54) POWER CONVERSION APPARATUS; MOTOR DRIVING APPARATUS, BLOWER, AND COMPRESSOR, EACH INCLUDING SAME; AND AIR CONDITIONER, REFRIGERATOR, AND FREEZER, EACH INCLUDING AT LEAST ONE OF THEM

(71) Applicant: Mitsubishi Electric Corporation, Tokyo (JP)

(72) Inventors: Keisuke UEMURA, Tokyo (JP); Kazunori HATAKEYAMA, Tokyo (JP); Yosuke SHINOMOTO, Tokyo (JP); Mitsuo KASHIMA, Tokyo (JP); Takashi MATSUMOTO, Tokyo (JP)

(21) Appl. No.: 15/505,370

(22) PCT Filed: Sep. 5, 2014
(86) PCT No.: PCT/JP2014/073582

§ 371 Date: Feb. 21, 2017

(51) Int. Cl. H02M 7/5387; F25D 29/00; F25D 17/06; F25B 49/02; H02P 5/74; H02M 1/08

(52) U.S. Cl. CPC H02M 7/53871; H02P 5/74; H02M 1/08; F25D 17/062; F25B 49/022; F25D 29/00; H02M 2001/0009

(57) ABSTRACT

A power conversion apparatus includes: an inverter to drive a motor, using a first carrier signal; an inverter connected in parallel to the inverter, to drive a motor, using a second carrier signal; respective phase lower arm shunt resistors to detect a first current flowing inside the inverter; respective phase lower arm shunt resistors to detect a second current flowing in the inverter; and a control unit to control the inverters. A phase difference is set between the first carrier signal and the second carrier signal to prevent a detection period for the first current in the first carrier signal and a detection period for the second current in the second carrier signal from overlapping each other when the inverters are controlled.

### CROSS REFERENCE TO RELATED APPLICATION

This application is a U.S. national stage application of International Patent Application. No. PCT/JP2014/073582 filed on Sep. 5, 2014, the disclosure of which is incorporated herein by reference.

### FIELD

The present invention relates to a power conversion apparatus; a motor driving apparatus, blower, and compressor, each including the same; and an air conditioner, refrigerator, and freezer, each including at least one of them.

### BACKGROUND

In a power conversion apparatus including three-phase inverters of a PWM modulation type and configured by disposing a bus in common to the respective inverters, there is adopted a technique of individually controlling motors connected to the respective inverters.

Since the respective inverters have the bus in common, and a composite current of currents flowing through the respective inverters flows through the bus, there may be a case where the ripple component of the bus current becomes larger, depending on the switching pattern of the respective inverters. Consequently, a smoothing capacitor connected to the bus increases heat generation, and thereby the capacitor may make progress of deterioration and end up shortening the service life. Further, in order to smooth larger current ripples, the capacitor needs to have larger capacitance, which leads to an increase in the size of the capacitor. Accordingly, there is disclosed a technique of suppressing the ripple component of a bus current to reduce heat loss caused by heat generation in a capacitor and a direct-current power supply line, for example, by “performing phase shift control onto the first carrier wave of a first inverter and the second carrier wave of a second inverter, to shift their phases from each other by a quarter period, in a case where a first electric motor and a second electric motor are in a common power running state in which both of them output torque in a direction the same as the rotational direction and perform power running, or they are in a common regeneration state in which both of them output torque in a direction opposite to the rotational direction and perform regeneration”, (for example, Patent Literature 1 listed below).

### CITATION LIST

### Patent Literature

Patent Literature 1: International Patent Application Laid-open No. 2012/073955

### SUMMARY

### Technical Problem

In the case of the above Patent Literature, the phases are changed while suppression of ripples of the bus current is paid attention to. However, in this case, there is a concern about deterioration of controllability ascribed to a delay in detection of a signal (such as a current detection signal) necessary for motor control.

Particularly, in a case that a shunt resistor is used as means for detecting a motor current, the current detection needs to be performed in accordance with switching of an inverter, and this problem becomes prominent if a delay at a sample hold circuit in an A/D converter (circuit) is large. Consequently, it is necessary to use a high-speed A/D conversion circuit or an A/D conversion circuit including a plurality of sample hold circuits, and thereby the apparatus may end up being higher in cost and larger in size.

The present invention has been made in view of the above, and an object of the present invention is to provide a power conversion apparatus that can detect a motor current without using a high-speed A/D conversion circuit or an A/D conversion circuit including a plurality of sample hold circuits.

### Solution to Problem

In order to solve the problems and achieve the object, according to an aspect of the present invention, there is provided a power conversion apparatus including: a first power converting unit to drive a first alternating-current load, using a first carrier signal; a second power converting unit connected in parallel to the first power converting unit, to drive a second alternating-current load, using a second carrier signal; a first current detecting unit to detect a first current flowing in the first power converting unit; a second current detecting unit to detect a second current flowing in the second power converting unit; and a control unit to control the first power converting unit and the second power converting unit, wherein a phase difference is set between the first carrier signal and the second carrier signal to prevent a detection period for the first current in the first carrier signal and a detection period for the second current in the second carrier signal from overlapping each other.

### Advantageous Effects of Invention

According to the present invention, there is provided an effect capable of detecting a motor current without using a high-speed A/D conversion circuit or an A/D conversion circuit including a plurality of sample hold circuits.

### BRIEF DESCRIPTION OF DRAWINGS

FIG. 1 is a view illustrating a configuration example of a motor driving apparatus including a power conversion apparatus according to an embodiment.

FIG. 2 is a view illustrating a configuration example of the control unit of the motor driving apparatus according to the embodiment.

FIG. 3 is a schematic diagram illustrating the relationship between the ON/OFF state of respective phase upper arm switching elements and the output voltage vector of an inverter, in a spatial vector modulation system.

FIG. 4 is a view illustrating the relationship between eight output voltage vectors and the ON/OFF state of respective phase upper arm switching elements.

FIG. 5 is a view illustrating currents flowing through respective portions inside a first inverter and a second inverter in a case where the output voltage vector of each of the inverters is a zero vector V0 (000).

FIG. 6 is a view illustrating the relationship of the carrier signals of the first inverter and the second inverter with respect to the detection timing of respective phase lower arm voltages.

FIG. 7 is a view illustrating the relationship of the carrier signals with respect to the detection timing of respective phase lower arm voltages, where a phase difference is given to the carrier signals illustrated in FIG. 6.

### DESCRIPTION OF EMBODIMENTS

An exemplary embodiment of a power conversion apparatus according to the present invention will be described below in detail with reference to the accompanying drawings. The present invention is not limited to the following embodiment.

### Embodiment

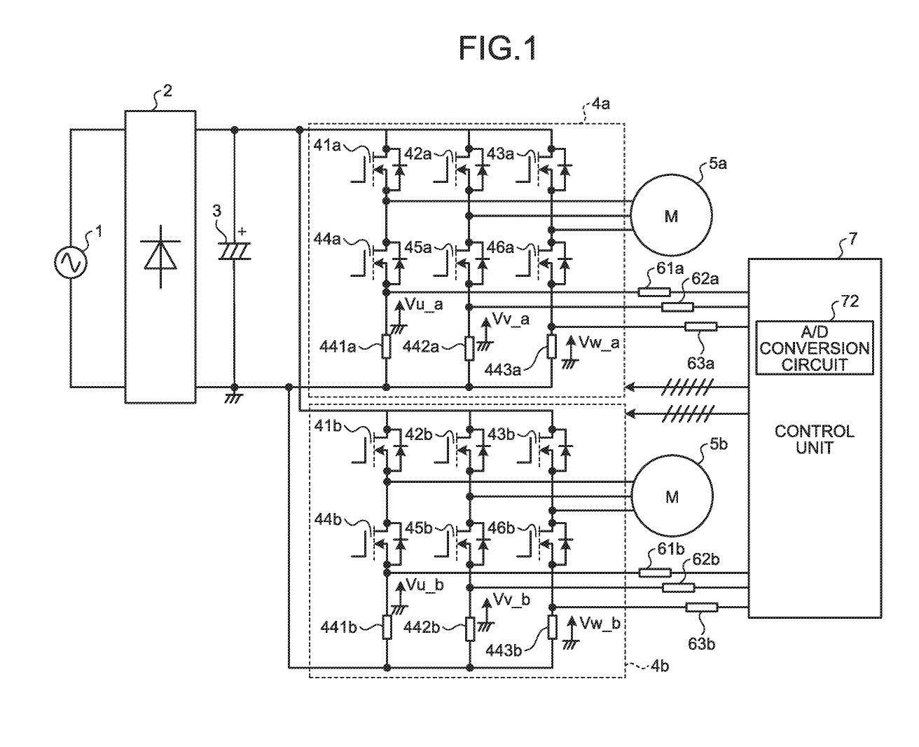

FIG. 1 is a view illustrating a configuration example of a motor driving apparatus including a power conversion apparatus according to an embodiment. In the motor driving apparatus according to the embodiment, as illustrated in FIG. 1, a power from an alternating-current power supply 1 is rectified by a rectifier 2, and is then smoothed by smoothing means 3, and thereby converted into a direct-current power. A first inverter 4a serving as a first power converting unit and a second inverter 4b serving as a second power converting unit are connected in parallel with each other, and are configured, as follows: The direct-current power smoothed by the smoothing means 3 is converted into three-phase alternating-current powers respectively by the first inverter 4a and the second inverter 4b, and the three-phase alternating-current powers are respectively supplied to a first motor 5a, which is a first alternating-current load, and a second motor 5b, which is a second alternating-current load. Hereinafter, for the sake of simplicity in description, components provided with reference symbols will be referred to in the description by omitting the appellations of “first” and “second”.

As the main components for supplying a three-phase alternating-current power to the motor 5a, the inverter 4a is composed of three arms, which are formed of upper arm switching elements (hereinafter, components provided with reference symbols will be referred to by omitting the appellation of “upper arm”) 41a to 43a (here, 41a: U-phase, 42a: V-phase, and 43a: W-phase) and lower arm switching elements (hereinafter, components provided with reference symbols will be referred to by omitting the appellation of “lower arm”) 44a to 46a (here, 44a: U-phase, 45a: V-phase, and 46a: W-phase). Similarly, as the main components for supplying a three-phase alternating-current power to the motor 5b, the inverter 4b is composed of three arms, which are formed of switching elements 41b to 43b (here, 41b: U-phase, 42b: V-phase, and 43b: W-phase) and switching elements 44b to 46b (here, 44b: U-phase, 45b: V-phase, and 46b: W-phase).

Further, as first current detecting units respectively disposed between the switching elements 44a to 46a and. the negative voltage side of the inverter 4a, the inverter 4a according to the embodiment includes respective phase lower arm shunt resistors (hereinafter, components provided with reference symbols will be referred to by omitting the appellation of “respective phase lower arm”) 441a, 442a, and 443a (here, 441a: U-phase, 442a: V-phase, and 443a: W-phase). Similarly, as second. current detecting units respectively disposed between the switching elements 44b to 46b and the negative voltage side of the inverter 4b, the inverter 4b includes shunt resistors 441b, 442b, and 443b (here, 441b: U-phase, 442b: V-phase, and 443b: W-phase). Here, the resistance value of each of the shunt resistors 441a, 442a, and 443a and 441b, 442b, and 443b is assumed to be Rsh.

Further, the inverter 4a and the inverter 4b according to the embodiment include voltage detecting units 61a to 63a as well as 61b to 63bfor detecting the potentials Vu_a, Vv_a, and Vw_a as well as Vu_b, Vv_b, and Vw_b of the shunt resistors 441a, 442a, and 443a as well as 441b, 442b, and 443b (hereinafter, these potentials will be referred to as “respective phase lower arm voltages”).

For example, a control unit 7 is formed of a microcomputer or CPU, and serves as arithmetic and control means for performing arithmetic and control in accordance with the control application of the motors 5a and 5b. Further, as illustrated in. FIG. 1, in the control unit 7 an A/D conversion circuit 72 is provided to convert an input analog voltage signal into a digital value.

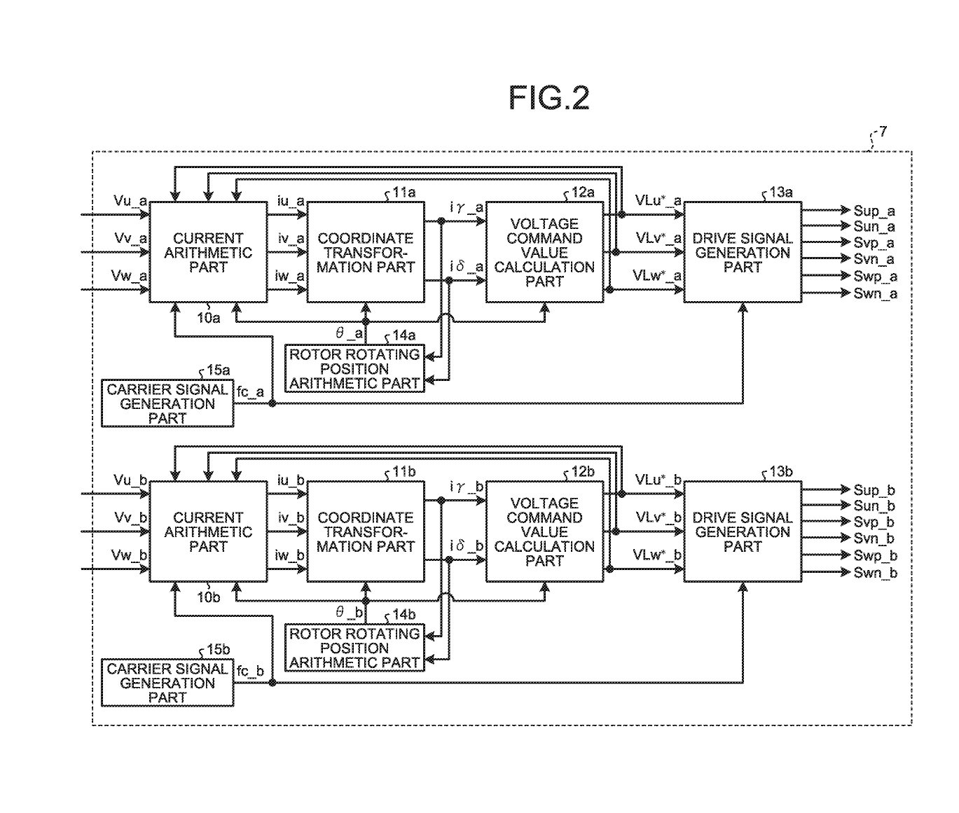

FIG. 2 is a view illustrating a configuration example of the control unit of the motor driving apparatus according to the embodiment. The control unit 7 according to the embodiment is sectionalized into an area associated. with the inverter 4a and an area associated with the inverter 4b.

In association with the inverter 4a, a current arithmetic part 10a is provided for computing respective phase currents iu_a, iv_a, and iw_a flowing to the respective phase windings of the motor 5a, based on respective phase lower arm voltages Vu_a, Vv_a, and Vw_a detected by the voltage detecting units 61a to 63a. A coordinate transformation part 11a provided for transforming the respective phase currents iu_a, iv_a, and iw_a, which are outputs from the current arithmetic part 10a, from a three-phase fixed coordinate system into a two-phase rotating coordinate system. A voltage command value calculation part 12a is provided for calculating respective phase voltage command values VLu*_a, VLv*_a, and VLw*_a to be output from the inverter 4a to the respective phase windings of the motor 5a, based on coordinate-transformed currents iγ_a and iδ_a obtained by the coordinate transformation of the respective phase currents iu_a, iv_a, and iw_a performed by the coordinate transformation part 11a. A drive signal generation part 13a is provided for generating respective drive signals Sup_a, Sun_a, Svp_a, Svn_a, Swp_a, and Swn_a to be output to the switching elements 41a to 43a and the switching elements 44a to 46a, based on the respective phase voltage command values VLu_a, Vlv*_a, and VLw*_a output from the voltage command value calculation part 12a. A rotor rotating position arithmetic part 14a is provided for computing a rotor rotating position θ_a of the motor 5a from the coordinate-transformed currents iγ_a and iδ_a. A carrier signal generation part 15a is provided for generating a carrier signal fc_a, such as a triangular wave or sawtooth wave, to be a reference frequency for the respective drive signals Sup_a, Sun_a, Svp_a, Svn_a, Swp_a and Swn_a.

In association with the inverter 4b, a current arithmetic part 10b is provided for computing respective phase currents iu_b, iv_b, and iw_b flowing to the respective phase windings of the motor 5b, based on respective phase lower arm voltages Vu_b, Vv_b, and Vw_b detected by the voltage detecting units 61b to 63b. A coordinate transformation part 11b is provided for transforming the respective phase currents iu_b, iv_b, and iw_b, which are outputs from the current arithmetic part 10b, from a three-phase fixed coordinate system into a two-phase rotating coordinate system. A voltage command value calculation part 12b is provided for calculating respective phase voltage command values VLu*_b, V*Lv_, and VLw*_b to be output from the inverter 4b to the respective phase windings of the motor 5b, based on coordinate-transformed currents iγ_b and iδ_b obtained by the coordinate transformation of the respective phase currents iu_b, iv_b, and iw_b performed by the coordinate transformation part 11b. A drive signal generation part 13b is provided for generating respective drive signals Sup_b, Sun_b, Svp_b, Svn_b, Swp_b, and Swn_b to be output to the switching elements 41b to 43b and the switching elements 44b to 46b, based on the respective phase voltage command values VLu*_b, VLv*_b, and VLw*_b output from the voltage command value calculation part 12b. A rotor rotating position arithmetic part 14b is provided for computing a rotor rotating position θ_b of the motor 5b from the coordinate-transformed currents iγ_b and iδ_b. A carrier signal generation part 15b is provided for generating a carrier signal fc_b, such as a triangular wave or sawtooth wave, to be a reference frequency for the respective drive signals Sup_b, Sun_b, Svp_b, Svn_b, Swp_b, and Swn_b.

It should be noted that the configuration of the control unit 7 described above is a mere configuration example for controlling the motor 5a and motor 5a as load apparatuses, and the present invention is not limited to the configuration or control method of this control unit 7.

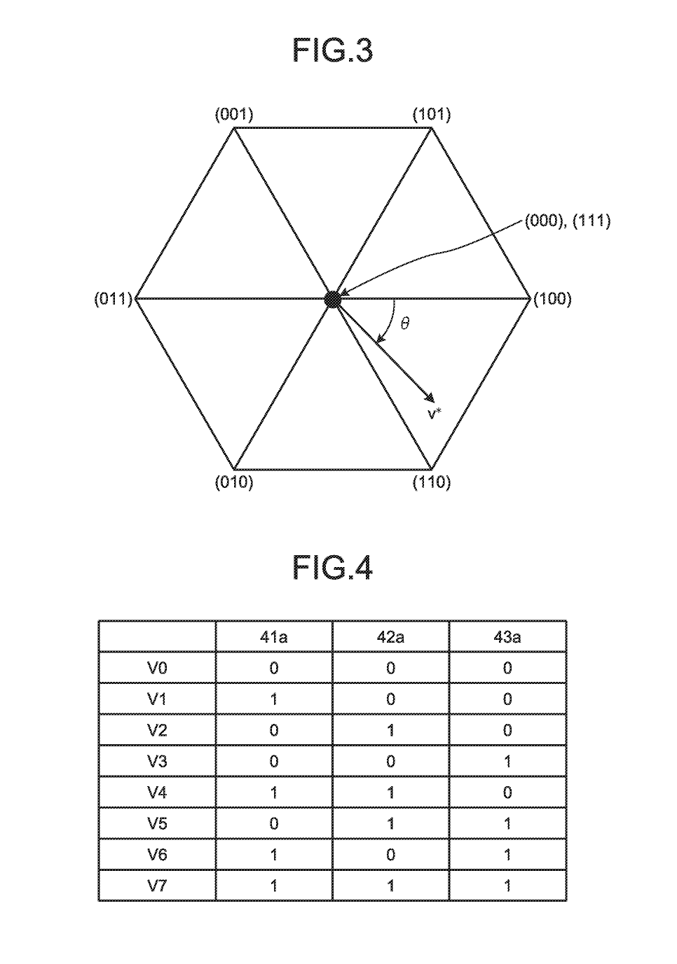

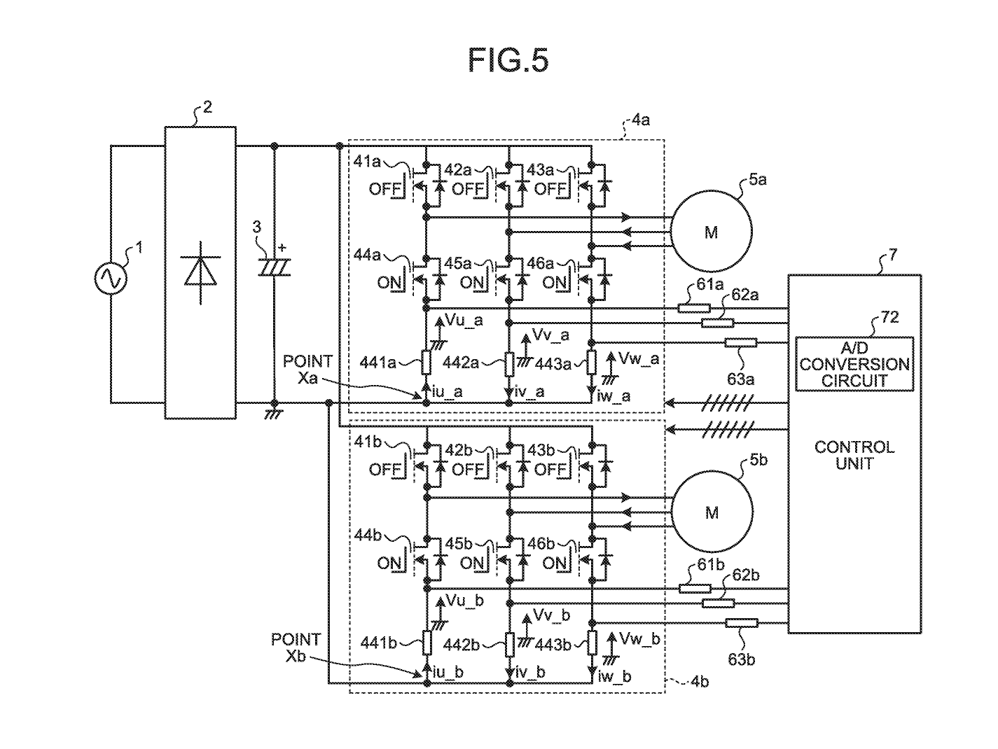

Next, with reference to FIGS. 3 and 4, an explanation will be given of a spatial vector modulation system in which drive signals to the switching elements 41a to 43a and 41b to 43b as well as the switching elements 44a to 46a and 44b to 46b are generated by means of PWM modulation. FIG. 3 is a schematic diagram illustrating the relationship between the ON/OFF state of the switching elements 41a to 43a and the output voltage vector of the inverter 4a, in the spatial vector modulation system. FIG. 4 is a view illustrating the relationship between eight output voltage vectors and the ON/OFF state of the switching elements 41a to 43a. Here, in the example illustrated in FIG. 4, the ON state of the switching elements 41a to 43a is defined by “1”, and the OFF state of them is defined by “0”.

As illustrated in FIG. 4, as the ON/OFF state of the switching elements 41a to 43a, there are two states consisting of the ON state (i.e., “1”) and the OFF state (i.e., “0”). Further, corresponding to combinations of the ON/OFF state of the switching elements 41a to 43a, if the output voltage vector of the inverter 4a is defined in the form of (the state of the U-phase switching element 41a), (the state of the V-phase switching element 42a) and (the state of the W-phase switching element 43a), there are eight vectors consisting of V0 (000), V1 (100), V2 (010), V3 (001), V4 (110), V5 (011), V6 (101), and V7 (111). In these output voltage vectors of the inverter 4a, each of the vectors V0 (000) and V7 (111) having no dimension will be referred to as “zero vector”, and each of the other vectors V1 (100), V2 (010), V3 (001), V4 (110), V5 (011), and V6 (101) having the same dimension as each other and having a phase difference of 60° from each other will be referred to as “real vector”

The control unit 7 combines the zero vectors V0 and V7 and the real vectors V1 to V6 by an arbitrary combination, and thereby generates drive signals of three-phase PWM voltage corresponding to the respective phase upper arm switching elements 41a to 43a and the respective phase lower arm switching elements 44a to 46a.

Further, also in the inverter 4b, drive signals of three-phase PWM voltage corresponding to the switching elements 41b to 43b and the switching elements 44b to 46b are generated by use of the same method as that in the inverter 4a described above.

Next, an explanation will be given of an arithmetic method for the respective phase currents iu_a, iv_a, and iw_a as well as iu_b, iv_b, and iw_b in the inverter 4a and the inverter 4b according to the embodiment.

FIG. 5 is a view illustrating currents flowing through respective portions inside the inverters 4a and 4b in a case where the output voltage vector of each of the inverter 4a and the inverter 4b is the zero vector V0 (000). In the example illustrated in FIG. 5, there are illustrated currents flowing inside the inverter 4a and the inverter 4b when the output voltage vector of each of the inverter 4a and the inverter 4b shifts from the real vector V1 (100) to the zero vector V0 (000), for example. In the example illustrated in FIG. 5, iu_a, iv_a, as well as iw_a and iu_b, iv_b, and iw_b respectively denote currents flowing from the high potential side to the low potential side in the respective phase windings of the motor 5a and the motor 5b. Further, the above explanation about FIG. 5 is applied also to the examples illustrated in the following drawings.

As illustrating in. FIG. 5, when the output voltage vector of the inverter 4a shifts from the real vector V1 (100) to the zero vector V0 (000): a U-phase current iu_a flows from a point Xa through the reflux diode of the U-phase switching element 44a toward the motor 5a; a V-phase current iv_a flows from the motor 5a through the V-phase switching element 45a and the V-phase shunt resistor 442a toward the point Xa; and a W-phase current iw_a flows through the W-phase switching element 46a toward the point Xa. At this time, the U-phase lower arm voltage Vu_a, the V-phase lower arm voltage VV_a, and the W-phase lower arm voltage Vw_a can be expressed by the following three formulas.

Vu_a=(−iu_a)×Rsh (1)

Vv_a=iv_a×Rsh (2)

Vw_a=iw_a×Rsh (3)

In other words, the respective phase currents iu_a, iv_a, and iw_a can be calculated by use of the above formulas (1), (2), and (3).

In the inverter 4b, similarly, when the output voltage vector of the inverter 4b shifts from the real vector V1 (100) to the zero vector V0 (000): a U-phase current iu_b flows from a point Xb through the reflux diode of the U-phase switching element 44b toward the motor 5b; a V-phase current iv_b flows from the motor 5b through the V-phase switching element 45b and the V-phase shunt resistor 442b toward the point Xb; and a W-phase current iw_b flows through the W-phase switching element 46b toward the point Xb. At this time, the U-phase lower arm voltage Vu_b, the V-phase lower arm voltage Vv_b, and the W-phase lower arm voltage Vw_b can be expressed by the following three formulas.

Vu_b=(−iu_b)×Rsh (4)

Vv_b=iv_b ×Rsh (5)

Vw_b=iw_b×Rsh (6)

In other words, the respective phase currents iu_b, iv_b, and iw_b can be calculated by use of the above formulas (4), (5), and (6).

As described above, according to the circuit configuration illustrated in FIG. 1, currents flowing to the motor 5a and the motor 5b can be calculated by detecting the respective phase lower arm voltages Vu_a, Vv_a, and Vw_a and Vu_b, Vv_b, and Vw_b.

Further, if a three-phase equilibrium condition formula is used for the motor 5a and the motor 5b, currents flowing to the motor 5a and the motor 5b can be calculated by detecting voltages of two phases among the respective phase lower arm voltages.

For example, in the inverter 4a, the U-phase lower arm voltage Vu_a and the V-phase lower arm voltage Vv_a are detected, and the U-phase current iu_a and the V-phase current iv_a are calculated by use of the formulas (1) and (2), and are substituted in a formula (7).

iu_a+iv_a+iw_a=0 (7)

Consequently, the W-phase current iw_a can be calculated.

Also in the inverter 4b, similarly, the U-phase lower arm voltage Vu_b and the V-phase lower arm voltage Vv_b are detected, and the U-phase current iu_b and the V-phase current iv_b are calculated by use of the formulas (4) and (5), and are substituted in a formula (8).

iu_b+iv_b+iw_b=0 (8)

Consequently, the W-phase current iw_b can be calculated.

As described above, in each of the inverter 4a and the inverter 4b, the respective phase motor currents can be calculated by detecting lower arm voltages of at least two phases.

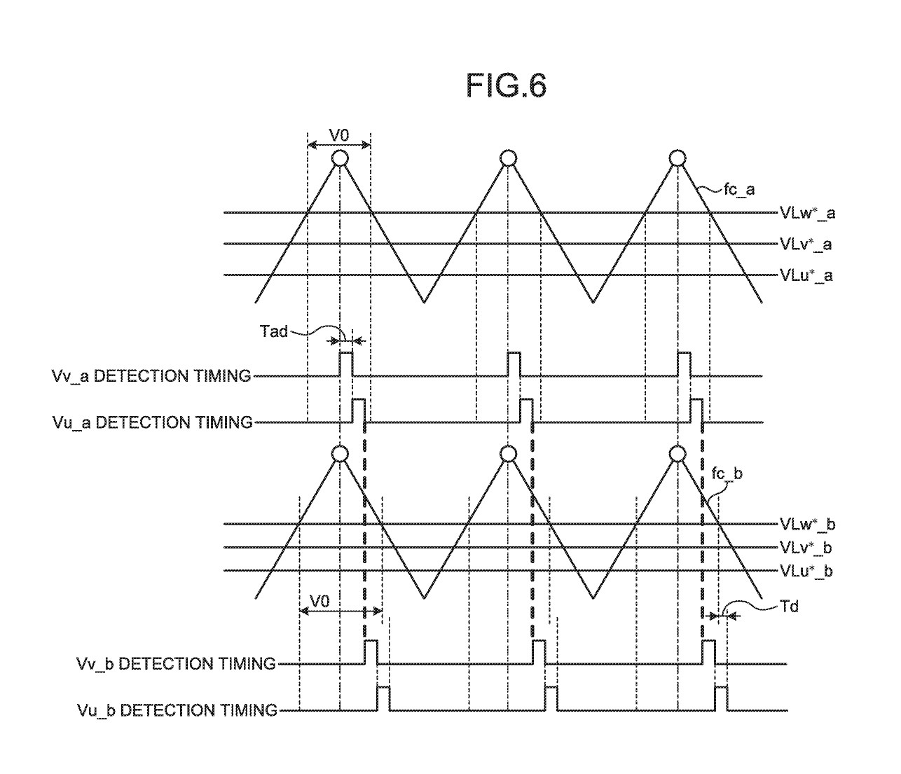

FIG. 6 is a view illustrating the relationship of the carrier signal fc_a for generating a drive signal of the inverter 4a and the carrier signal fc_b for generating a drive signal of the inverter 4b with respect to the detection timing of respective phase lower arm voltages in the inverter 4a and the inverter 4b. Here, in FIG. 6, there is illustrated an example where the U-phase lower arm voltage Vu_a and the V-phase lower arm voltage Vv_a are detected in the inverter 4a, and the U-phase lower arm voltage Vu_b and the V-phase lower arm voltage Vv_b are detected in the inverter 4b.

As described above, the control unit 7 detects the respective phase lower arm voltages Vu_a, Vv_a, Vu_b, and Vv_b, with the timing at which the inverter 4a and the inverter 4b output the zero vector V0 (000).

The respective phase lower arm voltages Vu_a, Vv_a, Vu_b, and Vv_b are analog values, which are converted into digital values by the A/D conversion circuit 72 of the control unit 7 (see FIG. 1). Here, the A/D conversion circuit 72 has an inherent delay time (Tad), and detects the respective phase lower arm voltages in accordance with a preset order. Here, in FIG. 6, there is illustrated an example where the voltages are detected in the order to Vv_a→Vu_a→Vv_b→Vu_b, while a top of the carrier signal fc_a is used as a trigger for starting the detection.

Further, in FIG. 6, there is illustrated a case where the carrier signal fc_a and the carrier signal fc_b are synchronized with each other without any phase difference therebetween.

In. FIG. 6, if the delay time Tad of the A/D conversion circuit 72 is considered, the U-phase lower arm voltage Vu_a and the V-phase lower arm voltage Vv_a in the inverter 4a as well as the V-phase lower arm voltage Vv_b in the inverter 4b can be detected in the period of the zero vector V0 (000). However, the U-phase lower arm voltage Vu_b in the inverter 4b, which is detected at the last, ends up protruding by Td from the timing at which the inverter 4b outputs the zero vector V0 (000). Consequently, if a detection value of the U-phase lower arm voltage Vu_b is applied as it is to the formula (4), an erroneous calculation result may be brought about. In this case, the motor control arithmetic could be adversely affected.

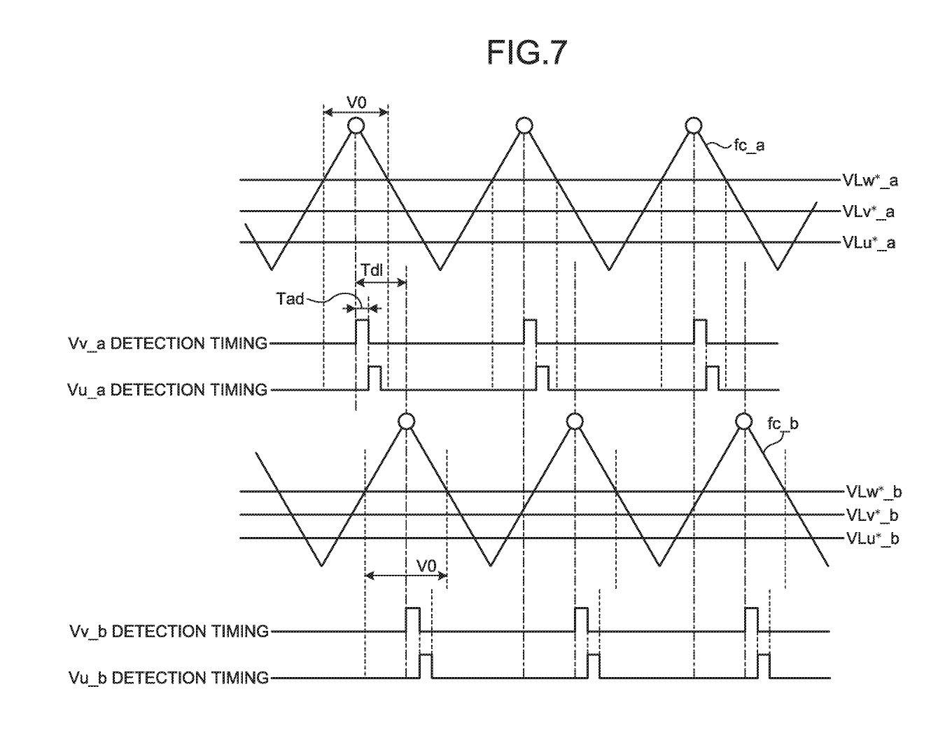

FIG. 7 is a view illustrating the relationship of the carrier signals with respect to the detection timing of respective phase lower arm voltages, where a phase difference is given to the carrier signals illustrated in FIG. 6. In FIG. 7, there is illustrated a case where a phase difference (Tdl) is given between the carrier signal fc_a and the carrier signal fc_b, under the same conditions as FIG. 6.

Where the phase difference Tdl is set between the carrier signal fc_a and the carrier signal fc_b, as illustrated in FIG. 7, all of the U-phase lower arm voltage Vu_a and the V-phase lower arm voltage Vv_a in the inverter 4a as well as the U-phase lower arm voltage Vu_b and the V-phase lower arm voltage Vv_b in the inverter 4b can have detection timing within the period in which the inverter 4a and the inverter 4b output the zero vector V0 (000). Accordingly, by setting the phase difference Tdl between the carrier signal fc_a and the carrier signal fc_b, the respective phase lower arm voltages can be accurately detected. If the phase difference Tdl is set to have a value equal to or larger than the total of delay times of the A/D conversion circuit 72 in detecting the respective phase lower arm voltages of the first inverter 4a, it is possible to prevent erroneous detection of the respective phase lower arm voltages.

As described above, by appropriately setting the phase difference Tdl between the first carrier signal fc_a and the second carrier signal fc_b, the respective phase lower arm voltages can be accurately detected, and thereby an improvement in motor controllability can be expected. Particularly, a microcomputer or DSP, which includes only one A/D conversion circuit or includes an A/D conversion circuit with a large delay Tad, can be applied to the control unit 7, and thus an inexpensive microcomputer or DSP can be applied to the control unit 7.

As descried above, the power conversion apparatus according to this embodiment includes: a first power converting unit to drive a first alternating-current load, using a first carrier signal; a second power converting unit connected in parallel to the first power converting unit, to drive a second alternating-current load, using a second carrier signal; a first current detecting unit to detect a first current flowing in the first power converting unit; a second current detecting unit to detect a second current flowing in the second power converting unit; and a control unit to control the first power converting unit and the second power converting unit. A phase difference is set between the first carrier signal and the second carrier signal to prevent a detection period for the first current in the first carrier signal and a detection period for the second current in the second carrier signal from overlapping each other. Consequently, it is possible to detect the motor current without using a high-speed A/D conversion circuit or an A/D conversion circuit including a plurality of sample hold circuits.

Here, this embodiment has been described with reference to an example about current detection performed by use of the shunt resistors inserted in the lower arms of each inverter. However, regardless of the insertion positions of the shunt resistors, or in relation to other sensors (such as position sensors), a detection delay is inevitably caused in practice, and the present invention is effective also to such cases.

Further, this embodiment has been exemplified by a case where the two inverters are used to drive two alternating-current loads (first and second motors). However, the present invention is not limited to this example, but may be applied to a configuration to drive three or more alternating-current loads.

Further, this embodiment has been described with reference to an example about a form where a direct-current power from a direct-current power supply is converted into a three-phase alternating-current power. However, the present invention is not limited to this embodiment, but may be applied to a configuration where a direct-current power from a direct-current power supply is converted into a single-phase alternating-current power.

Further, according to this embodiment, even if a motor driving apparatus is in a state where the number of revolutions of a motor is small and the output voltage of an inverter is not more than a limit value due to a direct-current voltage defined by the output of a smoothing capacitor, it is possible to effectively provide effects, such as loss reduction, power factor improvement, and input current harmonic reduction, as in the embodiment, by setting upper and lower limits of the on-duty Don. If such a motor driving apparatus is used to drive at least one of the motors of a blower and compressor in the structure of an air conditioner, refrigerator, or freezer, the same effect can be obtained.

The power conversion apparatus according to this embodiment has been described with reference to a case where the load is exemplified by a motor, and, in this way, it can be applied to a motor driving apparatus. This motor driving apparatus can be applied to a blower or compressor built in an air conditioner, refrigerator, or freezer.

According to this embodiment, even if a motor driving apparatus is in a state where the number of revolutions of a motor is small and the output voltage of an inverter is not more than a limit value due to a direct-current voltage defined by the output of a smoothing capacitor, it is possible to effectively provide effects, such as loss reduction, power factor improvement, and input current harmonic reduction, as in the embodiment, by setting upper and lower limits of the on-duty Don. If such a motor driving apparatus is used to drive at least one of the motors of a blower and compressor in the structure of an air conditioner, refrigerator, or freezer, the same effect can be obtained.

The configurations illustrated in the above embodiment are mere examples of the contents of the present invention, and they may be combined with other known techniques. Further, the configurations may be changed, e.g., by partial omission, without departing from the spirit of the present invention.

### INDUSTRIAL APPLICABILITY

As described above, the present invention is useful as a power conversion apparatus that can detect a motor current without using a high-speed A/D conversion circuit or an A/D conversion circuit including a plurality of sample hold circuits.

### REFERENCE SIGNS LIST

1 alternating-current power supply, 2 rectifier, 3 smoothing means, 4a inverter (first inverter), 4b inverter (second inverter), 5a motor (first motor), 5b motor (second motor), 7 control unit, 10a current arithmetic part (first current arithmetic part), 10b current arithmetic part (second current arithmetic part), 11a coordinate transformation part (first coordinate transformation part) , 11b coordinate transformation part (second coordinate transformation part) , 12a voltage command value calculation part (first voltage command value calculation part), 12b voltage command value calculation part (second voltage command value calculation part), 13a drive signal generation part (first drive signal generation part), 13b drive signal generation part (second drive signal generation part), 14a rotor rotating position arithmetic part (first rotor rotating position arithmetic part), 14b rotor rotating position arithmetic part (second rotor rotating position arithmetic part), 15a carrier signal generation part (first carrier signal generation. part), 15b carrier signal generation part (second carrier signal generation part), 41a, 41b switching element (U-phase upper arm switching element) , 42a, 42b switching element (V-phase upper arm switching element), 43a, 43b switching element (W-phase upper arm switching element) , 44a, 44b switching element (U-phase lower arm switching element), 45a, 45b switching element (V-phase lower arm switching element), 46a, 46b switching element (W-phase lower arm switching element), 61a to 63a voltage detecting unit (first voltage detecting unit), 61b to 63bvoltage detecting unit (second voltage detecting unit), 72 A/D conversion circuit, 441a U-phase lower arm shunt resistor (first current detecting unit), 441b U-phase lower arm shunt resistor (second current detecting unit), 442a V-phase lower arm shunt resistor (first current detecting unit), 442b V-phase lower arm shunt resistor (second current detecting unit) , 443a W-phase lower arm shunt resistor (first current detecting unit), 443b W-phase lower arm shunt resistor (second current detecting unit).

1. A power conversion apparatus comprising:
a first power converting unit to drive a first alternating-current load, using a first carrier signal;
a second power converting unit connected in parallel to the first power converting unit, to drive a second alternating-current load, using a second carrier signal;
a first current detecting unit to detect a first current flowing in the first power converting unit;
a second current detecting unit to detect a second current flowing in the second power converting unit; and
a control unit to control the first power converting unit and the second power converting unit,
wherein
there is a phase difference between the first carrier signal and the second carrier signal to prevent a detection period for the first current and a detection period for the second current from overlapping each other.

2. The power conversion apparatus according to claim 1, wherein the phase difference is equal to or larger than a detection delay time of the first current detecting unit.

3. The power conversion apparatus according to claim 1, wherein the first alternating-current load is a first motor and the second alternating-current load is a second motor.

4. The power conversion apparatus according to claim 3, wherein
the first motor includes a first position sensor for grasping a rotating position,
the second motor includes a second position sensor for grasping a rotating position, and
the phase difference is equal to or larger than a detection delay time of the first position sensor.

5. A motor driving apparatus for driving the first and second motors according to claim 3, the motor driving apparatus comprising the power conversion apparatus according to claim 3.

6. A blower comprising the power conversion apparatus according to claim 1.

7. A compressor comprising the power conversion apparatus according to claim 1.

8. An air conditioner comprising the blower according to claim 6.

9. A refrigerator comprising the blower according to claim 6.

10. A freezer comprising the blower according to claim 6.

11. An air conditioner comprising the compressor according to claim 7.

12. A refrigerator comprising the compressor according to claim 7.

13. A freezer comprising the compressor according to claim 7.
